(19) United States
(12) Patent Application Publication
(10) Pub. No.: US 2021/0347281 A1
(43) Pub. Date: Nov. 11, 2021

(54) Operating Unit for Specifying a Desired Value for a Height Adjustment Apparatus and Vehicle Seat

(71) Applicant: ADIENT ENGINEERING AND IP GMBH, BURSCHEID (DE)

(72) Inventors: Felix Antes, Erzenhausen (DE); Jan Hoffmann, Lohnsfeld (DE)

(73) Assignee: ADIENT ENGINEERING AND IP GMBH, BURSCHEID (DE)

(21) Appl. No.: 17/278,445

(22) PCT Filed: Oct. 11, 2019
(86) PCT No.: PCT/EP2019/077557

§ 371 Date: Mar. 22, 2021

(30) Foreign Application Priority Data
Oct. 12, 2018 (DE) 10 2018 125 275.7

(51) Int. Cl. B60N 2/02; B60N 2/16; G05G 5/26; G05G 1/04

(52) U.S. Cl. CPC B60N 2/0228; G05G 1/04; G05G 5/26; B60N 2/1685

(57) ABSTRACT

An operating unit for specifying a desired value for a height adjustment apparatus of a vehicle seat, in particular utility vehicle seat, where the operating unit may have an operating element for actuating the height adjustment apparatus. The operating element may be continuously adjustable. Further, a vehicle seat, in particular utility vehicle seat, with an operating unit for specifying a desired value for a height adjustment apparatus of the vehicle seat is provided.

The invention relates to an operating unit for specifying a desired value for a height adjustment apparatus of a vehicle seat, in particular utility vehicle seat, wherein the operating unit has an operating element, which is pivotable about an axis, for actuating the height adjustment apparatus, and to a vehicle seat.

### PRIOR ART

DE 10 2008 013 794 B3 discloses a vehicle seat, in particular a utility vehicle seat, with a scissors-type frame which is rockable and height-adjustable, with a gas compression spring and at least one pair of rockers which cross over each other at a scissors axis, and a control device for level control and for height adjustment of the scissors-type frame. The control device comprises a valve device with valves for activating the gas compression spring, a control link and a sensing member for sensing the control link, wherein the control link and the sensing member are kinematically assigned to different parts of the scissors-type frame which are movable relative to one another. The control link and the valve device are kinematically assigned to a first rocker and the sensing member to a second rocker. The control link is arranged pivotably about a pivot axis and for actuating the valve device. In order to change the height of the scissors-type frame, and therefore the height of the vehicle seat, the sensing member is rotated relative to the scissors axis by means of a cable pull. The sensing member thereby actuates the control link, as a result of which the valve device ventilates or vents the gas compression spring until the desired height is reached.

The rotation of the sensing member by means of the cable pull can take place by means of a latching switch, as is known, for example, from DE 10 2011 014 234 A1. Said latching switch permits the specification of a desired value and comprises a latching track with a plurality of latches, a lever which is pivotable about an axis, and at least one latching element which, by engagement in a latch, fixes the latching switch in a discrete latching position, wherein the latching element is of spring-like design.

### Problem

The invention is based on the problem of improving an operating unit for specifying a desired value for a height adjustment apparatus of the type mentioned at the beginning, in particular of enabling quiet actuation of the operating unit, and of providing a corresponding vehicle seat.

### Solution

This problem is solved according to the invention by an operating unit for specifying a desired value for a height adjustment apparatus of a vehicle seat, in particular utility vehicle seat, wherein the operating unit has an operating element, which is pivotable about an axis, for actuating the height adjustment apparatus, wherein the operating element is continuously adjustable.

The fact that the operating element is continuously adjustable makes it possible for an adjustment to be able to be carried out continuously by means of the operating unit without a negative background noise.

Advantageous refinements which can be used individually or in combination with one another are the subject matter of the dependent claims.

The height adjustment apparatus can be a height adjustment kinematics system. The height adjustment kinematics system can comprise a scissors-type frame.

The operating unit can have a holding element. The holding element can be connectable to a frame part of a vehicle seat, in particular to a seat frame side part. The holding element can have a holding section for fastening a Bowden cable, in particular a sheath of a Bowden cable.

The operating unit can have two sliding elements. The operating unit can have a first sliding element and a second sliding element. The sliding elements can each be of substantially semi-cylindrical configuration. The sliding elements can together take up a substantially cylindrical space which extends axially relative to an axis.

The sliding elements can be coated on an outer surface. A coating of the sliding elements can bring about a predetermined static friction on the surface of the sliding elements. A first of the two sliding elements can be fixedly connected to the holding element. The first sliding element can be fixedly connected to the holding element by means of at least two pins. The first sliding element can be connected to the holding element for rotation therewith.

The sliding elements can each have at least one bushing. One of the two sliding elements, in particular the first sliding element, can have two bushings. The bushings can be introducible with a clearance fit into the respective other sliding element, in particular the second sliding element. The sliding elements can be mounted by means of the bushings so as to be linearly displaceable relative to one another. The sliding elements can be linearly displaceable relative to one another and in the radial direction with respect to the axis by means of the bushings. The bushings can prevent rotation of the sliding elements relative to one another. The two sliding elements can be prestressed by means of a spring element, in particular a compression spring. The two sliding elements can be pressurized away from one another with a spring force. The two sliding elements can be pressurized away from one another with a spring force in the radial direction relative to the axis.

The operating unit can have a centering body. The centering body can be of substantially hollow-cylindrical configuration. The centering body can have a hollow-cylindrical section. The centering body, in particular in the region of the hollow-cylindrical section, can be coated on an inner side. On an outer side, the centering body can have a first half of a plug-in connection for fastening the operating element. The operating element can be plugged onto the centering body and held by means of the plug-in connection. The operating element can be clipped onto the centering body. The sliding elements can be arranged in the hollow-cylindrical section. In the region of the hollow-cylindrical section, the centering body can have an inner surface.

The surfaces of the sliding elements can be pressable onto the inner surface of the substantially hollow-cylindrical centering body by means of two spring elements, in particular two compression springs. The operating element can be held in the respectively set position by means of static friction in the event of loading. Manual actuation allows the static friction to be overcome and a differing desired value to be able to be set by means of the operating element.

The centering body can be mounted so as to be self-centering about an axis by means of the bracing between the two sliding elements. This axis at the same time corresponds to an axis of rotation of the operating element.

This problem is furthermore solved according to the invention by a vehicle seat, in particular utility vehicle seat, with an operating unit for specifying a desired value for a height adjustment apparatus of the vehicle seat according to the above description.

### FIGURES AND EMBODIMENTS OF THE INVENTION

Before refinements of the invention are described in greater detail below using drawings, it should first of all be noted that the invention is not restricted to the described components. Furthermore, the terminology which is used is also not of a restrictive nature, but rather has merely an exemplary character. If the singular is used below in the description and the claims, the plural is included in each case, insofar as the context does not explicitly rule this out.

The invention is explained in more detail below with reference to advantageous exemplary embodiments which are illustrated in the figures. However, the invention is not restricted to these exemplary embodiments. In the figures:

FIG. 1: shows a schematic illustration of a vehicle seat,

FIG. 2: shows a sectional illustration of a latching switch of the type in question,

FIG. 3: shows an exploded illustration of a first exemplary embodiment of an operating unit according to the invention,

FIG. 4: shows an illustration of the assembled operating unit from FIG. 3 with a Bowden cable,

FIG. 5: schematically shows a second exemplary embodiment of an operating unit according to the invention,

FIG. 6: schematically shows a sliding element of the second exemplary embodiment of the operating unit,

FIG. 7: shows an illustration of two sliding elements together with two spring elements of the second exemplary embodiment of the operating unit,

FIG. 8: shows an illustration of the two sliding elements from FIG. 7 prior to installation in a centering body of the second exemplary embodiment of the operating unit,

FIG. 9: shows an illustration of the centering body from FIG. 8 prior to installation in a holding element of the second exemplary embodiment of the operating unit, and

FIG. 10: shows an illustration of the second exemplary embodiment of the operating unit, prior to installation of an operating element.

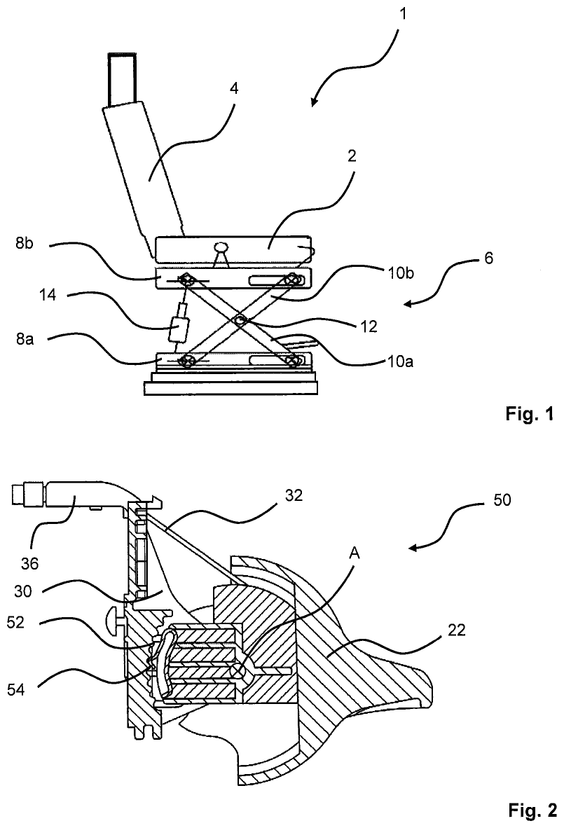

A vehicle seat 1, which is shown in FIG. 1, for a utility vehicle has a height adjustment kinematics system 6 which comprises a lower frame 8a, an upper frame 8b arranged above the latter and a pair of crossed first rockers 10a and second rockers 10b on either side. A transverse tube 12 connects the two crossing points and at the same time defines a scissors axis about which the rockers 10a, 10b can pivot relative to one another. The arrangement of the vehicle seat 1 within the vehicle and the customary direction of travel of said vehicle define the directional details used below. In this case, a direction oriented perpendicularly to the ground is referred to below as the vertical direction and a direction perpendicular to the vertical direction and perpendicular to the direction of travel is referred to below as the transverse direction.

The positional and directional details used, such as, for example, front, rear, top and bottom, relate in each case to a viewing direction of an occupant seated on a vehicle seat 1 in a normal seat position, wherein the vehicle seat 1 is installed in the vehicle and is oriented in a use position with an upright backrest 4 suitable for conveying people and as customary in the direction of travel. However, the vehicle seat 1 according to the invention can also be installed in a different orientation, for example transversely with respect to the direction of travel.

The first rockers 10a are connected to one another at their rear ends by means of a holding tube and are coupled to the upper frame 8b. At their front ends, the first rockers 10a are connected by means of a bearing tube and are guided movably in the longitudinal direction, which approximately corresponds to the direction of travel, on both sides by means of a respective bearing device in the lower frame 8a.

The second rockers 10b are connected to one another at their rear ends by means of a holding tube and are coupled to the lower frame 8a. At their front ends, the two rockers 10b are likewise connected by means of a bearing tube and are guided movably in the longitudinal direction on both sides by means of a respective bearing device in the upper frame 8b.

The transverse tube 12, the bearing tubes and the holding tubes extend here in the transverse direction, as does the scissors axis. A pivoting movement of the first rockers 10a relative to the second rockers 10b about the scissors axis changes the height of the upper frame 8b above the lower frame 8a, this being referred to below as height of the height adjustment kinematics system for short. By means of a gas spring 14 and preferably a damper, not illustrated here, the height adjustment kinematics system becomes a rockable system which decisively increases the seat comfort.

FIG. 2 shows a section through a latching switch 50 of the type in question which is used for specifying a desired value for a control device. Such a control device is known, for example, from DE 10 2008 013 794 B3 and is used for adjusting the seat height of a vehicle seat.

The latching switch 50 comprises a holding element 30 on which a slotted connecting link 52 having a plurality of latches is formed. The slotted connecting link 52 is in the form of a segment of a ring gear, wherein the latches are formed on the inner surface of said ring gear segment and face radially inward. The latches are arranged at equidistant intervals from one another. The holding element 30 comprises two bearing points in which an operating element 22 is rotatably mounted. The center axes of the bearing points are aligned and form an axis A about which the operating element 22 is pivotable relative to the holding element 30 and relative to the slotted connecting link 52.

The end of the operating element 22 facing the holding element 30 has a latching region to which two shaped springs 54 are fastened here. The shaped springs 54 are designed as separate components and are connected to the operating element 22 in a form-fitting manner. Each shaped spring 54 is in the form of a leg spring. The end of the shaped springs 54 facing the slotted connected link 52 has a latching lug which protrudes radially outward with respect to the axis A and engages in a latch of the slotted connecting link 52.

The holding element 30 has a holding section 36 in which a first end of a Bowden cable 32 is held. A desired value for the seat height of the vehicle seat is predetermined at the aforementioned control unit depending on the latching position in which the latching switch is secured.

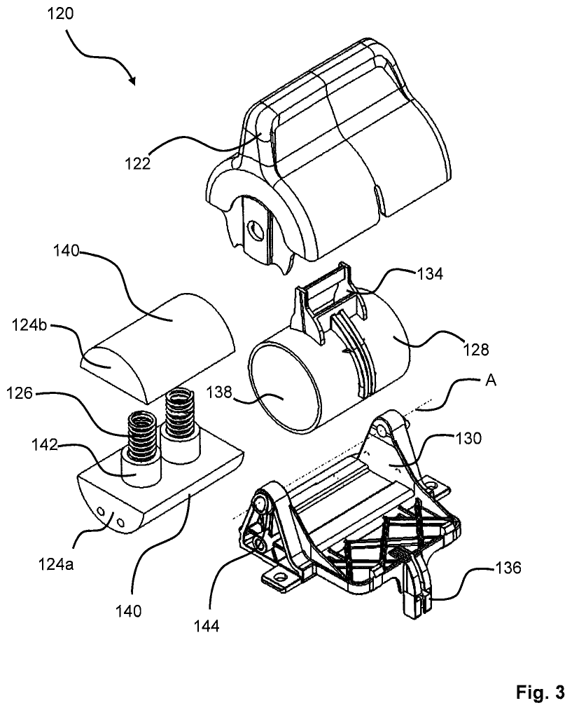

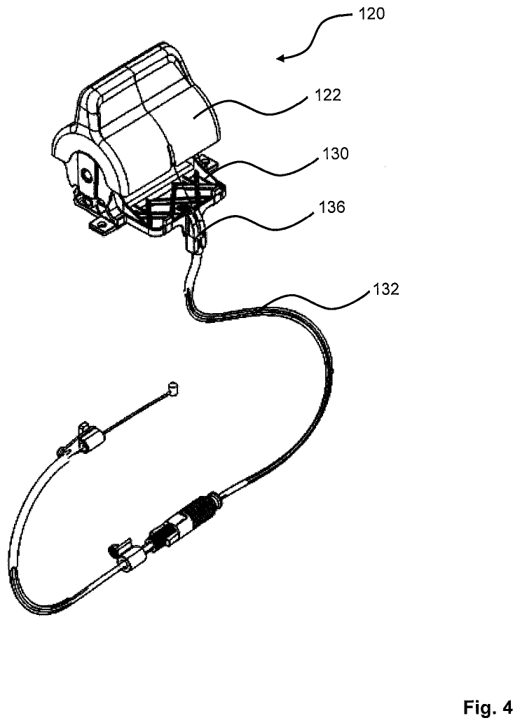

FIGS. 3 and 4 show a first exemplary embodiment of the operating unit 120 according to the invention. The operating unit 120 has a holding element 130. The holding element 130 is connectable to a frame part of a vehicle seat 1, in particular to a seat frame side part. The holding element 130 has a holding section 136 for fastening a Bowden cable 132, in particular a sheath of the Bowden cable 132.

The operating element 120 has two sliding elements 124a, 124b. The sliding elements 124a, 124b are in each case of substantially semi-cylindrical configuration. The sliding elements 124a, 124b together take up a substantially cylindrical space which extends axially relative to an axis A.

The sliding elements 124a, 124b can be coated on an outer surface 140. The sliding element 124a is connected fixedly to the holding element 130. The sliding element 124a is connected to the holding element 130 for rotation therewith, preferably by means of pins, not illustrated. The sliding element 124a has two bushings 142. The bushings 142 can be introduced into the other sliding element 124b with a clearance fit. The sliding elements 124a, 124b are linearly displaceable relative to one another and in the radial direction with respect to the axis A by means of the bushings 142. The sliding elements 124a, 124b are secured against rotation relative to one another by means of the bushings 142. The two sliding elements 124a, 124b are prestressed by means of a spring element 126, here two spring elements 126. The spring elements 126 are compression springs. The two sliding elements 124a, 124b are pressurized away from one another with a spring force in the radial direction relative to the axis A.

The operating unit 120 has a centering body 128. The centering body 128 is of substantially hollow-cylindrical configuration. The centering body 128 has a hollow-cylindrical section. On an outer side, the centering body 128 has a receptacle 134 for fastening a core of the Bowden cable 132. On an outer side, the centering body 128 furthermore has a first half of a plug-in connection for fastening the operating element 122. The operating element 122 is plugged onto the centering body 128 and held by means of a clip connection. The operating element 122 is mounted, in particular mounted rotatably, on the holding element 130 at two axially outwardly oriented axle bolts 144. To allow the operating element 122 to be plugged on more easily, the axle bolts 144 are beveled counter to a plugging-on direction. The first half of the plug-in connection and the receptacle 134 for fastening the Bowden cable 132 are configured together here.

The sliding elements 124a, 124b are arranged within the hollow-cylindrical section. In the region of the hollow-cylindrical section, the centering body 128 has an inner surface 138. The surface 140 of the sliding elements 124a, 124b can be pressed onto the inner surface 138 of the centering body 128 by means of the spring elements 126. The operating element 122 is held in the respectively set position by means of static friction between the surfaces 140 of the sliding elements 124a, 124b and inner surface 138 of the centering body 128. Manual actuation allows the static friction to be overcome and a changed desired value to be set by means of the operating element 122. The centering body 128 is mounted so as to be self-centering about an axis A by means of the bracing at the two sliding elements 124a, 124b. This axis A at the same time corresponds to an axis of rotation of the operating element 122.

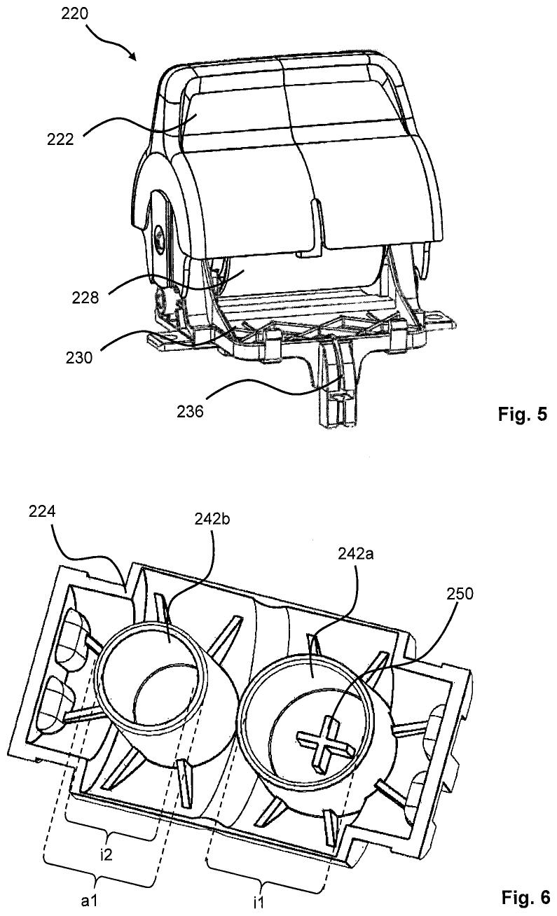

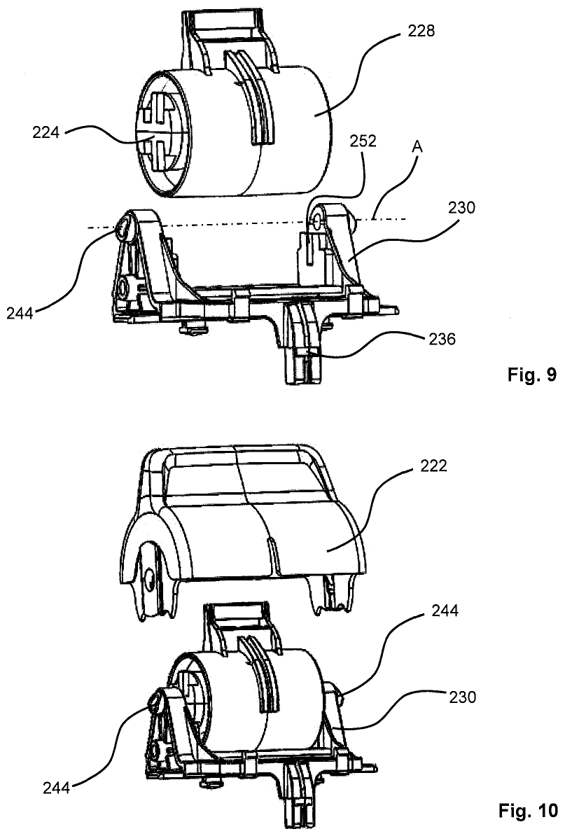

FIGS. 5 to 10 show a second exemplary embodiment of an operating unit 220 according to the invention which, unless explicitly described differently, substantially corresponds to the first exemplary embodiment of the operating unit 120. Similar or identical parts to those in the first exemplary embodiment in each case bear a reference sign increased by 100.

The operating unit 220 has a holding element 230. The holding element 230 is connectable to a frame part of a vehicle seat 1, in particular to a seat frame side part. The holding element 230 has a holding section 236 for fastening a Bowden cable, in particular a sheath of the Bowden cable. The operating unit 220 has a centering body 228. The centering body 228 is of substantially hollow-cylindrical configuration. The centering body 228 has a hollow-cylindrical section. On an outer side, the centering body 228 has a receptacle 234, which is concealed in the illustration of FIG. 5, for fastening a core of the Bowden cable. On an outer side, the centering body 228 furthermore has a first half of a plug-in connection for fastening the operating element 222. The operating element 222 is plugged onto the centering body 228 and held by means of a plug-in connection. The first half of the plug-in connection and the receptacle 234 for fastening the Bowden cable are configured together here. In relation to the connection and the interaction with the Bowden cable, the second exemplary embodiment of the operating unit 220 corresponds substantially to the first exemplary embodiment of the operating unit 120.

FIG. 6 shows a sliding element 224 of the operating unit 220. The operating unit 220 has two such sliding elements 224 which are configured as identical parts. The sliding elements 224 each have a substantially semi-cylindrical outer surface. The sliding elements 224 together take up a substantially cylindrical space when said sliding elements are appropriately brought together. This cylindrical space extends axially relative to the axis A.

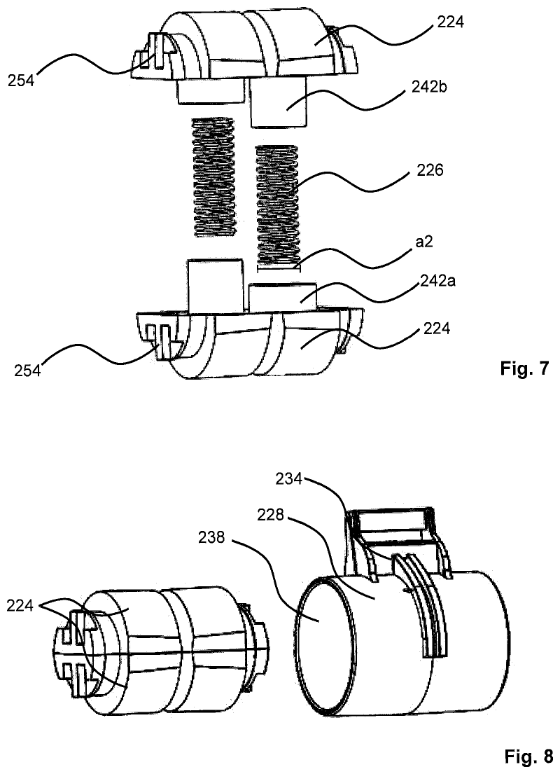

The sliding elements 224 can be manufactured as injection molded parts. The sliding elements 224 can be coated on an outer surface 240. On an inner side, the sliding elements 224 have two cylindrical bushings 242a, 242b, in particular a first bushing 242a and a second bushing 242b. The first bushing 242a has an inside diameter i1. A centering pin 250 is arranged in a base region of the first bushing 242a. The centering pin 250 can be of cross-shaped configuration. The centering pin 250 is used for centering mounting of a first end of a spring element 226 illustrated in FIG. 7.

The second bushing 242b has an outside diameter a1. The second bushing 242b has an inside diameter i2. The outside diameter a1 of the second bushing 242b is coordinated with the inside diameter i1 of the first bushing 242a in such a manner that, when two sliding elements 224 are joined together, the second bushing 242b of each one of the two sliding elements 224 is guided inside the first bushing 242a of the respective other of the two sliding elements 224. The sliding elements 224 are linearly displaceable relative to one another and in the radial direction with respect to the axis A. The sliding elements 224 are secured against rotation relative to one another by means of the bushings 242a, 242b. The interdependency of the outside diameter a1 of the respective second bushings 242b and the respective inside diameters i1 of the first bushings 242a furthermore avoids installation errors since only one functional connection of the two sliding elements 224 to each other is possible. This is clarified in the state shown in FIG. 7.

FIGS. 7 to 10 show a series of states of the respectively illustrated parts of the operating unit 220 during the assembly of the operating unit 220.

The inside diameter i2 of the second bushing 242b is preferably slightly larger than an outside diameter a2 of the spring element 226, as a result of which the spring element 226 can be guided in the respective second bushing 242b of the two sliding elements 224.

Also advantageously and for easier differentiability, there can be provision for the first bushing 242a and the second bushing 242b of a respective sliding element 224 to differ in height.

The two sliding elements 224 are prestressed by means of a spring element 226, here two spring elements 226. The spring elements 226 are compression springs. The two sliding elements 224 are pressurized away from one another with a spring force in the radial direction relative to the axis A.

The two joined-together sliding elements 224 can then be introduced in the axial direction into a hollow-cylindrical section of the centering body 228. Owing to the spring prestressing of the two sliding elements 224, the outer surface 240 of the sliding elements 224 comes into flat contact with the inner surface 238 of the centering body 228.

A first connecting part of a tongue-and-groove-type connection is formed on the two axially oriented end faces of the sliding elements 224. In the present case, the sliding elements 224 each have a spring 254 on their end face. The corresponding, respective, other connecting part of the tongue-and-groove-type connection, here a groove 252, is formed on the holding element 230. When the sliding elements 224 are appropriately aligned, the springs 254 arranged on the end faces of the sliding elements 224 can be introduced into the corresponding grooves 252 of the holding element 230 when the centering body 228 and the holding element 230 are joined together. The springs 254 secure the applicable sliding element 224 merely against rotation in the grooves 252 of the holding element 230. A radial movement of the applicable sliding element 224 continues to be permitted by the linear guidance of the springs 254 in the grooves 252. Therefore, one of the two sliding elements 224 is held directly, and the other sliding element 224 is held indirectly, on the holding element 230.

Finally, the operating element 222 is plugged onto the centering body 228 in the region of the receptacle 234 and onto the holding element 230. In this instance, the operating element 222 is mounted, in particular mounted rotatably, on the holding element 230 at two axially outwardly oriented axle bolts 244. To allow the operating element 222 to be plugged on more easily, the axle bolts 244 are beveled counter to a plugging-on direction.

The features which are disclosed in the above description, the claims and the drawings may be of significance both individually and in combination for implementing the invention in its various refinements.

Although the invention has been described in detail in the drawings and the preceding description, the descriptions should be understood as being illustrative and exemplary and not restrictive. In particular, the choice of the graphically illustrated proportions of the individual elements should not be interpreted as being required or restrictive. Furthermore, the invention is in particular not restricted to the exemplary embodiments explained. Further variants of the invention and the implementation thereof are apparent to a person skilled in the art from the preceding disclosure, the figures and the claims.

Terms such as “comprise”, “have”, “include”, “contain” and the like which are used in the claims do not rule out further elements or steps. The use of the indefinite article does not rule out a plural. A single device can carry out the functions of a plurality of units or devices mentioned in the claims.

### LIST OF REFERENCE SIGNS

1 Vehicle seat
2 Seat part
4 Backrest
6 Height adjustment kinematics system
8a Lower frame
8b Upper frame
10a First rocker
10b Second rocker
12 Transverse tube
14 Gas spring
22 Operating element
30 Holding element
32 Bowden cable
36 Holding section
50 Latching switch
52 Slotted connecting link
54 Shaped spring
120, 220 Operating unit
122, 222 Operating element
124a Sliding element
124b Sliding element
126, 226 Spring element
128, 228 Centering body
130, 230 Holding element
132 Bowden cable
134, 234 Receptacle
136, 236 Holding section
138, 238 Inner surface
140, 240 Surface
142 Bushing
144, 244 Axle bolt
224 Sliding element
242a Bushing
242b Bushing
250 Centering pin
252 Groove
254 Spring
a1 Outside diameter (of the bushing 242b)
a2 Outside diameter (of the spring element 226)
i1 Inside diameter (of the bushing 242a)
i2 Inside diameter (of the bushing 242b)
A Axis

1-15. (canceled)

16. An operating unit for specifying a desired value for a height adjustment apparatus of a vehicle seat, wherein the operating unit has an operating element for actuating the height adjustment apparatus, wherein the operating element continuously adjustable.

17. The operating unit as claimed in claim 16, wherein the operating unit has a holding element which is connectable to a frame part of the vehicle seat, including to a seat frame side part.

18. The operating unit as claimed in claim 16, wherein the operating unit has two sliding elements.

19. The operating unit as claimed in claim 18, wherein the sliding elements together take up a substantially cylindrical space which extends axially relative to an axis.

20. The operating unit as claimed in claim 18, wherein the sliding elements are coated on an outer surface.

21. The operating unit as claimed in claim 16, wherein a first of the two sliding elements is connected to the holding element for conjoint rotation.

22. The operating unit as claimed in claim 16, wherein at least one of the sliding elements has at least one bushing.

23. The operating unit as claimed in claim 22, wherein the at least one bushing can be introduced with a clearance fit into the respective other sliding element.

24. The operating unit as claimed in claim 22, wherein the sliding elements are mounted with the at least one bushing so as to be linearly displaceable relative to one another, and in the radial direction with respect to the axis (A).

25. The operating unit as claimed in claim 22, wherein the at least one bushing prevents rotation of the sliding elements relative to one another.

26. The operating unit as claimed in claim 18, wherein the two sliding elements are prestressed by a spring element, including a compression spring.

27. The operating unit as claimed in claim 16, wherein the operating unit has a centering body, including a centering body of substantially hollow-cylindrical configuration.

28. The operating unit as claimed in claim 27, wherein the centering body is mounted so as to be self-centering about an axis (A) by the prestressing of the two sliding elements.

29. The operating unit as claimed in claim 19, wherein the axis (A) corresponds to an axis of rotation of the operating element.

30. A vehicle seat, including utility vehicle seat, with an operating unit for specifying a desired value for a height adjustment apparatus of the vehicle seat as claimed in claim 16.
